(19) United States
(12) Patent Application Publication
(10) Pub. No.: US 2025/0365278 A1
(43) Pub. Date: Nov. 27, 2025

(54) Methods and Apparatuses for Providing Vehicle Service Data

(71) Applicant: Bayerische Motoren Werke Aktiengesellschaft, Muenchen (DE)

(72) Inventors: Matthias FINK, Muenchen (DE); Thomas Nachbar, Poing (DE)

(21) Appl. No.: 19/171,640

(22) Filed: Apr. 7, 2025

(30) Foreign Application Priority Data
May 24, 2024 (DE) 10 2024 114674.5

(51) Int. Cl. H04L 9/40; G07C 5/00; G07C 5/08; H04W 4/40; H04W 4/80

(52) U.S. Cl. CPC H04L 63/0823; G07C 5/008; G07C 5/0825; H04W 4/40; H04W 4/80

(57) ABSTRACT

A method for providing service data relating to a vehicle by a key device having a digital key for interacting with the vehicle stored in a secure storage unit of the key device, the method including receiving service data via a wireless communication connection between the key device and the vehicle, storing the service data in the secure storage unit, and providing the service data in response to a request from a vehicle application executed on the key device.

### CROSS REFERENCE TO RELATED APPLICATION

This application claims priority under 35 U.S.C. § 119 from German Patent Application No. 10 2024 114 674.5, filed May 24, 2024, the entire disclosure of which is herein expressly incorporated by reference.

### BACKGROUND AND SUMMARY

The present disclosure relates to methods and corresponding apparatuses for providing service data for a (motor) vehicle in connection with a digital vehicle key.

A vehicle may have a vehicle key with a storage unit in which service data relating to the vehicle can be stored. Exemplary service data are the vehicle identification number (VIN), condition data relating to the condition of the vehicle, the registration date of the vehicle, the model and/or model variant of the vehicle, diagnostic data, etc. The service data can be read from the vehicle key by a servicing service for servicing the vehicle. In this context, the vehicle key must be taken by the user to the servicing service and handed over to the servicing service.

The present document deals with the technical object of enhancing and efficiently increasing the convenience and reliability of providing vehicle service data for digital vehicle keys.

This object is achieved by the present disclosure. Advantageous embodiments are also described herein. It is pointed out that additional features of a patent claim dependent on an independent patent claim, without the features of the independent patent claim or in combination only with a subset of the features of the independent patent claim, may form a standalone invention that is independent of the combination of all of the features of the independent patent claim and may be made into the subject matter of an independent claim, a divisional application or a subsequent application. This applies in the same way to technical teachings that are described in the description and may form an invention independent of the features of the independent patent claims.

One aspect describes a method for providing service data relating to a (motor) vehicle by a key device, wherein the key device has a digital key for interacting with the vehicle, wherein the (actual) identity of the digital key is stored in a secure storage unit of the key device. The method can be carried out by a key applet of the secure storage unit.

The key device may be a (mobile and/or electronic and/or handheld) user device, such as a smartphone or a smart device. A digital key may be intended to be stored in the more secure storage area (in particular in the secure element) of the key device. The digital key can be designed in accordance with the Car Connectivity Consortium, CCC, key standard, in particular in accordance with CCC Release 3.

The service data may indicate, for example, the vehicle identification number (VIN) of the vehicle;
the model and/or the model variant of the vehicle;
the date of manufacture and/or registration of the vehicle;
the color code of the color of the vehicle;
condition information relating to the condition of the vehicle, e.g. the mileage, the condition and/or the filling level of the tank or the high-voltage store; and/or
diagnostic information relating to one or more fault messages of the vehicle; and/or
data provided by a backend server.

The method comprises receiving service data via a wireless communication connection between the key device and the vehicle. The communication connection between the key device and the vehicle may comprise a Bluetooth Low Energy (BLE) communication connection and/or a Near Field Communication (NFC) communication connection.

Before receiving the service data, the communication connection may have been established (automatically) between the key device and the vehicle. Furthermore, the key device may have been authenticated at the vehicle by the digital key stored in the secure storage unit. This allows service data to be provided in a secure manner.

In addition, the method may comprise receiving a Message Authentication Code (MAC) for the service data. The MAC may have been determined via the digital key. The integrity of the service data can be verified on the basis of the MAC and via the digital key. Alternatively or additionally, the service data may have been signed (by the vehicle). The on-board digital key (which was also used to establish the secure communication connection) may have been used for this purpose. The signature can then be checked (by the user device) (via the device's digital key). This allows the reliability of the provided service data to be increased further.

The method also comprises storing the service data in the secure storage unit. The service data can be stored in particular in the mailbox of the digital key (within the secure storage unit).

Furthermore, the method comprises providing the service data in response to a request from a vehicle application executed on the key device. The vehicle application can be the SW application of the vehicle manufacturer of the vehicle, wherein the SW application is provided, for example, by an OEM (Original Equipment Manufacturer).

Providing the service data may comprise determining a signature of the service data via the digital key, and/or verifying the service data via the signature. This allows the reliability of the provided data to be increased further.

The service data can be made available to the vehicle application (which is executed on the key device). Within the scope of the method, it is possible to cause (by the vehicle application) the service data to be able to be transmitted to an external unit (e.g. a receiving unit of a servicing service), wherein the external unit is arranged outside the key device.

Causing the service data to be able to be transmitted to an external unit may comprise
generating and displaying a machine-readable code (in particular a QR code) representing the service data; the code can be displayed on a screen of the key device; and/or
causing the service data to be sent to the external unit via short-range communication, in particular via NFC.

This allows service data for a vehicle to be made available to an external unit (e.g. a servicing service) in a particularly convenient and reliable manner.

Another aspect describes a method for providing service data relating to a vehicle on a key device, wherein the key device has a digital key for interacting with the vehicle, and wherein the digital key is stored in a secure storage unit of the key device. The method can be carried out e.g. by a control apparatus (in particular by a control device) of the vehicle.

The method comprises authenticating the key device via the digital key via a wireless (BLE and/or NFC) communication connection between the key device and the vehicle. Furthermore, the method comprises, in response to the authentication, sending service data to the key device, in particular to the secure storage unit of the key device, via the wireless communication connection between the key device and the vehicle.

The method may also comprise generating a Message Authentication Code (MAC) for the service data via the digital key, and sending the MAC to the key device via the wireless communication connection between the key device and the vehicle. Alternatively or additionally, the service data may be signed (by the vehicle). The on-board digital key (which was also used to establish a secure communication connection) may be used for this purpose. The signature can then be checked by the user device (via the device's digital key). This makes it possible to efficiently ensure the integrity of the service data provided.

It should be noted that the methods can be used, in particular carried out, in combination with each other.

Another aspect describes a software (SW) program. The SW program can be configured to be executed on a processor and to thereby carry out one or more of the methods described in this document.

Another aspect describes a storage medium. The storage medium may comprise an SW program that is configured to be executed on a processor and to thereby carry out one or more of the methods described in this document.

Another aspect describes an apparatus for providing service data relating to a vehicle via a key device, wherein the key device has a digital key for interacting with the vehicle, wherein the digital key is stored in a secure storage unit of the key device. The apparatus is configured to receive service data from the vehicle via a wireless communication connection between the key device and the vehicle, and to store the service data in the secure storage unit. The apparatus is also configured to provide the service data in response to a request from a vehicle application executed on the key device.

Another aspect describes an apparatus for providing service data relating to a vehicle on a key device, wherein the key device has a digital key for interacting with the vehicle, which is stored in a secure storage unit of the key device. The apparatus is configured to authenticate the key device via the digital key via a wireless communication connection between the key device and the vehicle. The apparatus is further configured, in response to the authentication, to send service data to the key device, in particular to the secure storage unit of the key device, via the wireless communication connection between the key device and the vehicle.

Another aspect describes a key applet for a digital key. The key applet can be arranged in a data store, in particular a secure data store, (in particular in a secure element) of the key device, in which the digital key is also stored. The key applet may be designed to carry out the method described in this document.

Another aspect describes a (mobile and/or portable) user device (e.g. a smart device and/or a smartphone) which comprises the apparatus (in particular the vehicle application) and/or the key applet.

Another aspect describes a (road) motor vehicle (in particular a passenger vehicle or a commercial vehicle or a bus or a motorcycle) that comprises the apparatus described in this document.

It should be noted that the aspects described in connection with a method, in particular the claims described in connection with a method, can also be applied as corresponding apparatus features to an apparatus.

It should be noted that the methods, apparatuses and systems described in this document may be used both on their own and in combination with other methods, apparatuses and systems described in this document. Furthermore, any aspects of the methods, apparatuses and systems described in this document may be combined with one another in a wide variety of ways. The features of the claims may in particular be combined with one another in a wide variety of ways. Furthermore, features in parentheses should be understood as optional features.

The present disclosure is described in more detail below with reference to exemplary embodiments.

### BRIEF DESCRIPTION OF THE DRAWINGS

FIG. 1a shows an exemplary digital access system of a vehicle;

FIG. 1b shows an exemplary key device;

FIG. 1c shows exemplary possible ways of transmitting vehicle service data to a servicing service;

FIG. 2 shows a flowchart of actions for providing vehicle service data; and

FIGS. 3a and 3b each show a flowchart of an exemplary method for providing vehicle service data.

### DETAILED DESCRIPTION OF THE DRAWINGS

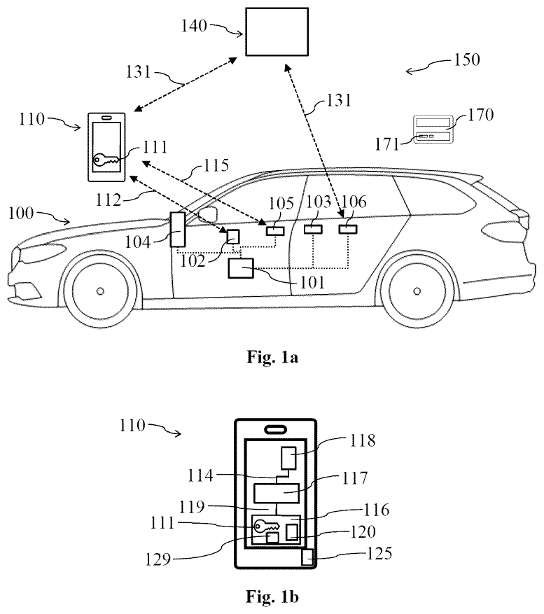

As explained at the outset, the present document deals with the convenient and secure provision of vehicle service data, e.g. to a vehicle servicing service. In this context, FIG. 1a shows an exemplary (access) system 150 that comprises a vehicle 100 and a digital key device 110. The digital key device 110 is typically a portable electronic device, such as for example a smartphone or a tablet PC, wherein a digital key 111 is stored on the portable electronic device. The digital key 111 may be stored in a protected storage area, in particular in a so-called “secure element”, of the portable electronic device (such as the user device).

The digital key device 110 is designed to communicate with a communication unit 102, 105 of the vehicle 100 via one or more different wireless communication connections 112, 115. Exemplary communication connections 112, 115 are a Bluetooth Low Energy (BLE) communication connection 112 and/or a Near Field Communication (NFC) communication connection 115.

The system 150 optionally further comprises a central processing unit 140, e.g. a backend unit or a backend server, which is configured to communicate with the digital key device 110 and/or with the vehicle 100 (in particular with a communication unit 106 of the vehicle 100) via a respective wireless communication connection 131 (e.g. via a 3G, 4G, 5G communication connection).

A (control) apparatus 101 of the vehicle 100 may be designed to control at least one vehicle function 103 of the vehicle 100 on the basis of the communication between the device 110 and the vehicle 100. In this context, the digital key 111 of the device 110 may be verified, in particular authenticated. Furthermore, after successful authentication, one or more vehicle functions 103 can be controlled, in particular on the basis of
the distance between the device 110 and the vehicle 100;
the position of the device 110 relative to the vehicle 100; and/or
a control command that is sent from the device 110 to the vehicle 100 via a communication connection 112, 115.

The range of the one or more vehicle functions 103 which can be controlled by the key device 110 may depend on one or more properties of the digital key 111. In particular, it can be made possible to activate one or more vehicle functions 103 and/or block one or more vehicle functions 103 via the digital key 111.

FIG. 1b shows details of the electronic (key) device 110. In particular, FIG. 1b shows the secure storage area 116, in particular the so-called “secure element”, in which the digital key 111 of the key device 110 and possibly an attestation of this digital key 111 can be stored. An attestation may comprise data that make it possible to teach the digital key 111 of the key device 110 to the vehicle 100. The data contained in the attestation may make it possible for the vehicle 100 to check the authenticity of the digital key 111.

A software application 120, which is also executed in the secure storage area 116, can be stored in the secure storage area 116. The software application 120 may be designed to perform one or more functions with respect to the digital key 111, for example the encryption and/or decryption and/or signing of data with the digital key 111 (in particular with the private key part of the digital key 111). Signing data (in particular service data) with the digital key 111 makes it possible for a recipient of the signed data to recognize data manipulation and/or verify the author of the data. The software application 120 for providing one or more key-related functions is also referred to as a key applet in this document.

The storage area 116 can be read by the operating system and/or by a control apparatus 117 of the device 120 via a (secure) data interface 119. In particular, interaction between the control apparatus (in particular the operating system) 117 of the key device 110 and the key applet 120 can be made possible via a data interface 119, e.g. in order to enable the control apparatus 117 to cause the key applet 120 to encrypt (for example sign) or to decrypt data with the digital key 111 and/or to provide data from the secure storage area 116 or to store data in the secure storage area 116.

Further, the control apparatus (in particular the operating system) 117 may be designed to interact with a software application 118 of the vehicle manufacturer via a further data interface 114, for example in order to forward data from the storage area 116, for example the digital key 111 and/or the attestation and/or vehicle service data. The software application 118 of the manufacturer of the vehicle 100 may be designed to interact (directly) with the central processing unit 140 (of the manufacturer of the vehicle 100) (via the communication connection 131). If necessary, it can be made possible for the central processing unit 140 to interact directly (without incorporating the software application 118) with the control apparatus 117 of the key device 120 and/or with the secure storage area 116. The SW application 118 of the vehicle manufacturer (which is provided, for example, by an OEM (Original Equipment Manufacturer)) is also referred to as vehicle application 118 in this document.

The key device 110 typically comprises at least one communication unit 125 which is designed to establish a communication connection 112, 115 to a communication unit 102, 105 of the vehicle 100 (e.g. a BLE communication connection 112 and/or an NFC communication connection 115). The data to be transmitted can be provided and/or received directly by the key applet 120 and/or directly by the control apparatus 117.

As an alternative or in addition to a key device 110 with a digital key 111, it is possible to provide a (physical) vehicle key 170 for a vehicle 100, wherein the vehicle key 170 optionally also makes it possible to remotely control one or more vehicle functions 103. The vehicle key 170 may be configured to communicate with the vehicle 100 via a (possibly proprietary) wireless communication connection. During communication with the vehicle 100, vehicle service data 171 can be transmitted from the vehicle 100 to the vehicle key 170 and stored in a storage unit of the vehicle key 170. Exemplary service data 170 are the VIN of the vehicle 100;
the model and/or the model variant of the vehicle 100;
the color code of the color of the vehicle 100;
the date of manufacture and/or registration of the vehicle 100;
condition information relating to a condition of the vehicle 100, e.g. the mileage and/or the condition or the filling level of the tank or the high-voltage store; and/or
diagnostic information relating to one or more (current) fault messages of the vehicle 100.

The service data 171 stored on the vehicle key 170 can be read by a suitable reading unit, e.g. when servicing the vehicle 100. This makes it possible for the user of the vehicle 100 to transfer servicing-relevant data relating to the vehicle 100 to the servicing service in a convenient and precise manner.

It may happen that the user of the vehicle 100 is not carrying the vehicle key 170 when handing over the vehicle 100 to a servicing service. On the other hand, the user typically always carries his user device 110. It can therefore be made possible to store the service data 171, as an alternative or in addition to the storage on the vehicle key 170, in a storage unit, in particular in the secure storage unit 116, of the key device 110. For this purpose, it can be made possible for the vehicle 100 to transmit the service data 171 to the key device 110 via the communication connection 112, 115.

The service data 171 stored on the key device 110 can then be transmitted, if required, from the key device 110 to a servicing service in a convenient and reliable manner, as illustrated by way of example in FIG. 1c. In particular, a reader 160 can be used to transmit the service data 171 from the storage unit 116 of the key device 110 (via the vehicle application 118 of the key device 110) to the reader 160 via a wireless communication connection 161 (e.g. via NFC). Alternatively or additionally, the vehicle application 118 on the key device 110 may be designed to generate a machine-readable code 163, in particular a QR (Quick Response) code, which comprises the service data 171. The code 163 can be displayed on the screen of key device 110 and captured by the camera of a user device of the servicing service in order to transmit the service data 171 to the servicing service. Alternatively or additionally, the service data 171 can be sent to the servicing service via a parts function 162 of the vehicle application 118 on the key device 110 via a suitable communication application (e.g. email).

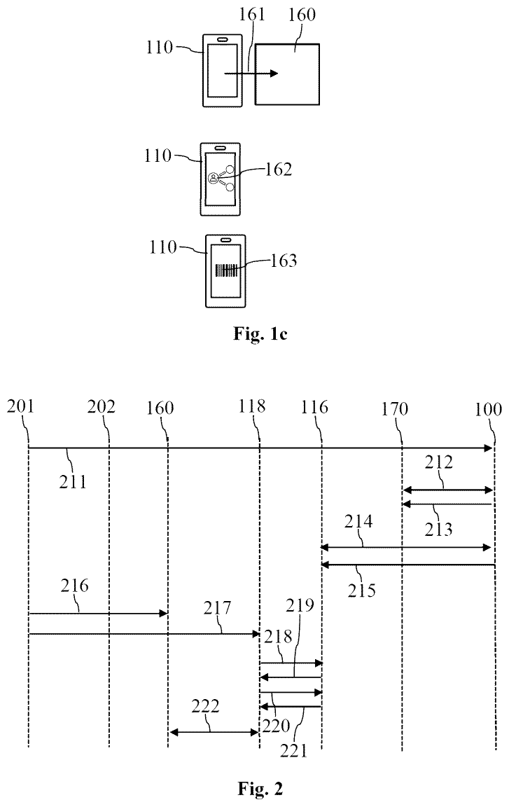

FIG. 2 shows an exemplary flowchart of actions in connection with the storage and provision of service data 171 via a key device 110. The flowchart illustrates the following entities:
user 201 of the key device 110;
servicing personnel 202;
external unit, in particular receiving unit 160 (for the service data 171);
vehicle application 118 (on the key device 110);
secure storage unit 116 (on the key device 110);
vehicle key 170; and
vehicle 100.

The user 201 can approach the vehicle 100 with the vehicle key 170 (action 211), which results in an authentication process 212 being carried out between the vehicle key 170 and the vehicle 100 after a communication connection has been established between the vehicle key 170 and the vehicle 100. After successful authentication, the service data 171 from the vehicle 100 are transmitted to the vehicle key 170 (action 213) and stored in a storage unit of the vehicle key 170.

In a corresponding manner, the user 201 can approach the vehicle 100 with the key device 110. After a communication connection 112, 115 has been established between the key device 110 and the vehicle 100, and after the key device 110 has been successfully authenticated (action 214), the service data 171 can be transmitted from the vehicle 100 to the secure storage unit 116 of the key device 110 via the communication connection 112, 115 and stored in the secure storage unit 116 (action 215). The interaction with the vehicle 100 can be effected by the key applet 120 of the storage unit 116.

Furthermore, the vehicle 100 can generate a Message Authentication Code (MAC) for the service data 171 (possibly using the digital key 111, i.e. the public key part of the digital key 111). The MAC can be sent to the key device 110 via the communication connection 112, 115. This allows the integrity of the service data 171 to be verified by the key device 110.

For reading the service data 171 from the vehicle key 170, the user can arrange the vehicle key 170 in the vicinity of a suitable receiving unit 160 (of the servicing service) (action 216). The service data 171 can then be read by the receiving unit 160.

In order to provide the service data 171 from the key device 110, the user 201 can open the vehicle application 118 and initiate the provision of the service data 171 stored in the storage unit 116 of the key device 110 via the user interface of the vehicle application 118 (action 217). The vehicle application 118 can then send (via the operating system 117 of the key device 110) a request to provide the service data 171 to the key applet 120 of the storage unit 116 (action 218). In response, the service data 171 can be made available to the vehicle application 118 (action 219).

In order to confirm the correctness of the service data 171, the vehicle application 118 can request that a digital signature be provided for the service data 171 (action 220). Alternatively, the service data 171 can be provided directly with a digital signature (without the need to request the digital signature in a dedicated manner). The signature can then be provided by the key applet 120 of the storage unit 116 (action 221).

In a final action 222, the receiving unit 160 of the servicing service and the vehicle application 118 can interact in order to provide the service data 171 (as described in connection with FIG. 1c).

In particular, the mailbox 129 for the digital key 111 in the secure storage unit 116 of the key device 110 can be used to store the vehicle service data 171, for example in order to be able to make the service data 171 available to a dealer 202. This may allow the dealer 202 to verify the data integrity of the service data 171.

The vehicle application 118 on the key device 110 can display the service data 171 by QR code 163 on the screen of the key device 110 so that the dealer 202 can scan the code 163 when handing over the vehicle 100 for servicing. The vehicle 100 may be designed to calculate a message authentication code (MAC) and append it to the service data 171 in order to ensure the integrity of the service data 171. Alternatively or additionally, the service data 171 can be signed with a key on the key device 110 of the user 201.

As described in connection with FIG. 2, the vehicle 100 can regularly update the service data 171 in the mailbox 129 of the digital key 111, e.g. (each time) when the vehicle 100 interacts with the digital key 111. In order to provide the service data 171, the user 201 can open the vehicle application 118 and initiate the provision of the service data 171 via the user interface of the vehicle application 118. The vehicle application 118 reads the service data 171 from the mailbox 129 of the digital key 111. The service data 171 can be signed.

The service data 171 can be transmitted by QR code 163. For this purpose, the service data 171 are displayed as a QR code 163 on the screen of the key device 110. The dealer 202 scans the QR code and stores the service data 171, e.g. together with the vehicle service registration, in a database of the dealer 202. Alternatively or additionally, the service data 171 can be transmitted using NFC. For this purpose, the vehicle application 118 configures the key device 110 for NFC data transmission (registration for NFC request, selection of the desired digital key, etc.). Furthermore, the vehicle application 118 may request the user 201 to hold the key device 110 to the reader 160. The service data 171 can then be read by the reader 160 using NFC. Alternatively or additionally, the service data 171 can be provided using another proximity sharing method.

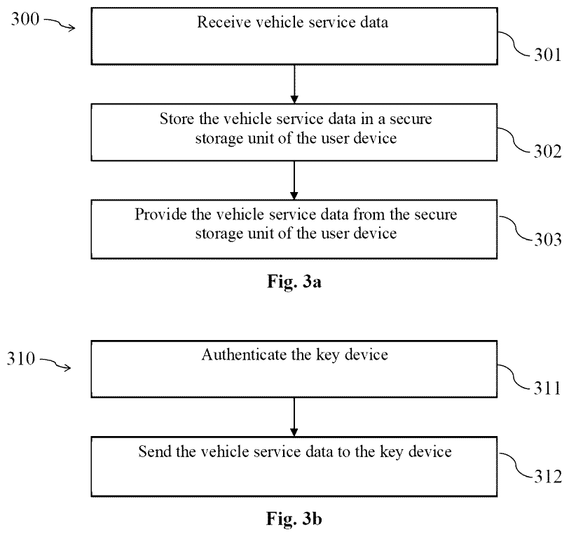

FIG. 3a shows a flowchart of an exemplary (possibly computer-implemented) method 300 for providing service data 171 relating to a (motor) vehicle 100 via a key device 110, wherein the key device 110 has a digital key 111 for interacting with the vehicle 100, wherein the digital key 111 is stored in a secure storage unit 116 of the key device 110. The key device 110 can be a (mobile) user device, such as a smartphone. The method 300 can be carried out by the key device 110, in particular by the key applet 120 of the secure storage unit 116.

The method 300 comprises receiving 301 service data 171 via a wireless (BLE and/or NFC) communication connection 112, 115 between the key device 110 and the vehicle 100. Furthermore, the method 300 comprises storing 302 the service data 171 in the secure storage unit 116 (in particular in the mailbox 129 of the digital key 111). Furthermore, the method 300 comprises providing 303 the service data 171 in response to a request from the vehicle application 118 executed on the key device 110. The service data 171 can be transferred to the vehicle application 118, and the vehicle application 118 can cause the service data 171 to be forwarded to an external unit 160 (e.g. to the receiving unit of a servicing service).

FIG. 3b shows a flowchart of an exemplary (possibly computer-implemented) method 310 for providing service data 171 relating to a (motor) vehicle 100 to a key device 110, wherein the key device 110 has a digital key 111 for interacting with the vehicle 100, which is stored in a secure storage unit 116 of the key device 110. The method 310 can be carried out by a control apparatus 101 of the vehicle 100.

The method 310 comprises authenticating 311 the key device 110 via the digital key 111 via a wireless (BLE and/or NFC) communication connection 112, 115 between the key device 110 and the vehicle 100. Furthermore, the method 310 comprises, in response to the authentication 311, sending 312 service data 171 to the key device 110, in particular to the secure storage unit 116 of the key device 110, via the wireless communication connection 112, 115 between the key device 110 and the vehicle 100.

The measures described in this document can make it possible to provide vehicle service data in a particularly convenient and secure manner.

The present invention is not restricted to the exemplary embodiments that are shown. It should in particular be noted that the description and the figures are intended to illustrate the principle of the proposed methods, apparatuses and systems only by way of example.

What is claimed is:

1. A method for providing service data relating to a vehicle by a key device, wherein the key device has a digital key for interacting with the vehicle, which is stored in a secure storage unit of the key device, the method comprising:
receiving service data via a wireless communication connection between the key device and the vehicle;
storing the service data in the secure storage unit; and
providing the service data in response to a request from a vehicle application executed on the key device.

2. The method according to claim 1, comprising:
before receiving the service data:
establishing the communication connection between the key device and the vehicle; and
authenticating the key device at the vehicle via the digital key stored in the secure storage unit.

3. The method according to claim 1, wherein the service data are stored in a mailbox of the digital key.

4. The method according to claim 1, comprising:
receiving a Message Authentication Code (MAC) and/or a signature for the service data; and
verifying integrity of the service data on a basis of the MAC and/or the signature and via the digital key.

5. The method according to claim 1,
wherein the service data are made available to the vehicle application,
the method comprising causing the service data to be able to be transmitted to an external unit.

6. The method according to claim 5,
wherein causing the service data to be able to be transmitted to an external unit comprises:
generating and displaying a machine-readable code representing the service data; and/or
causing the service data to be sent to the external unit via short-range communication.

7. The method according to claim 1,
wherein providing the service data comprises:
determining a signature of the service data via the digital key; and/or
verifying the service data via the signature.

8. The method according to claim 1,
wherein the communication connection between the key device and the vehicle comprises a Bluetooth Low Energy (BLE) communication connection and/or a Near Field Communication (NFC) communication connection.

9. The method according to claim 1,
wherein the digital key is configured in accordance with the Car Connectivity Consortium (CCC) key standard.

10. The method according to claim 1, comprising:
carrying out the method by a key applet of the secure storage unit.

11. The method according to claim 1, wherein the service data comprise:
a vehicle identification number;
a model and/or a model variant of the vehicle;
a date of manufacture and/or registration of the vehicle;
a color code of a color of the vehicle;
condition information relating to a condition of the vehicle comprising a mileage of the vehicle and/or a filling level of a fuel tank or a high-voltage store of the vehicle; and/or
diagnostic information relating to one or more fault messages of the vehicle.

12. A method for providing service data relating to a vehicle on a key device, wherein the key device has a digital key for interacting with the vehicle, which is stored in a secure storage unit of the key device, the method comprising:
authenticating the key device via the digital key via a wireless communication connection between the key device and the vehicle; and
in response to the authentication, sending service data to the secure storage unit of the key device via the wireless communication connection between the key device and the vehicle.

13. The method according to claim 12, comprising:
generating a Message Authentication Code (MAC) and/or a signature for the service data via the digital key; and
sending the MAC and/or the signature to the key device via the wireless communication connection between the key device and the vehicle.

14. An apparatus for providing service data relating to a vehicle via a key device, wherein the key device has a digital key for interacting with the vehicle, which is stored in a secure storage unit of the key device, wherein the apparatus is configured to:
receive service data from the vehicle via a wireless communication connection between the key device and the vehicle;
store the service data in the secure storage unit; and
provide the service data in response to a request from a vehicle application executed on the key device.

15. The apparatus according to claim 14, wherein the apparatus is configured to:
before receiving the service data:
establish the communication connection between the key device and the vehicle; and
authenticate the key device at the vehicle via the digital key stored in the secure storage unit.

16. The apparatus according to claim 14, wherein the service data are stored in a mailbox of the digital key.

17. The apparatus according to claim 14, wherein the apparatus is configured to:
receive a Message Authentication Code (MAC) and/or a signature for the service data; and
verify integrity of the service data on a basis of the MAC and/or the signature and via the digital key.

18. The apparatus according to claim 14,
wherein the service data are made available to the vehicle application,
wherein the apparatus is configured to cause the service data to be able to be transmitted to an external unit.

19. The apparatus according to claim 14,
wherein the apparatus is configured to provide the service data by:
determining a signature of the service data via the digital key; and/or
verifying the service data via the signature.

20. The apparatus according to claim 14,
wherein the communication connection between the key device and the vehicle comprises a Bluetooth Low Energy (BLE) communication connection and/or a Near Field Communication (NFC) communication connection.
